(19) United States
(12) Patent Application Publication
(10) Pub. No.: US 2008/0284674 A1
(43) Pub. Date: Nov. 20, 2008

(54) Digital control architecture for a tunable impedance surface

(75) Inventors: Paul R. Herz, Santa Monica, CA (US); Daniel F. Sievenpiper, Santa Monica, CA (US)

Correspondence Address: Richard P. Berg, Esq.;c/o LADAS & PARRY, Suite 2100, 5670 Wilshire Boulevard, Los Angeles, CA, 90036-5679, US

(73) Assignee: HRL LABORATORIES, LLC

(21) Appl. No.: 11/803,752

(22) Filed: May 15, 2007

(51) Int. Cl. H01Q 15/00; H01Q 3/00

(52) U.S. Cl. 343/909

(57) ABSTRACT

A digitally controlled tunable impedance surface. The tunable impedance surface is of the type having a two dimensional array of conducting plates disposed adjacent a dielectric medium; a ground plane spaced from the two dimensional array of conducting plates, the dielectric medium occurring at least between and separating the two dimensional array of conducting plates and the ground plane; and conductors coupling alternating ones of the conducting plates to the ground plane. A plurality of voltage controlled capacitors are coupled between adjacent plates in the two dimensional array of conducting plates and an array of digital to analog converters are disposed preferably on or near the ground plane. Each digital to analog converter has analog output voltage pads coupled to selected ones of adjacent conducting plates and has at least a digital input for receiving digital words representing at least in part analog voltages to be applied to the selected ones of the adjacent conducting plates. The digital to analog converter may also have a digital output for serially coupled the received digital data words to downstream connected digital to analog converters.

### TECHNICAL FIELD

This invention relates a control architecture that can efficiently and simply control voltage and current signals to structured high impedance surface which reflects, steers, or focuses electromagnetic radiation. The disclosed architecture implements a digital control signal scheme and utilizes digital-to-analog (D/A) microchips (or in alternative manner A/D microchips) to deliver voltage and current signals over many independent sites across a tunable impedance surface. The surface s impedance is adjusted by the local application of voltage signals and can impart an almost arbitrary phase shift to the incident wave using tunable electrical components of the surface.

### BACKGROUND INFORMATION

Ordinary metal surfaces reflect electromagnetic radiation with a a phase shift. However high impedance materials have recently been invented at HRL Laboratories of Malibu, Calif. See, e.g., U.S. Pat. Nos. 6,538,621 and 6,552,696, which describe materials are capable of reflecting, steering, or focusing RF radiation with a variable phase shift by tuning the impedance of the surfaces. U.S. Pat. No. 6,538,621 describes a technique for tuning the surface impedance, and thus the reflection phase using various mechanical methods. By programming the reflection phase as a function of position on the surface, a reflected beam can be steered or focused.

The present invention involves a new control architecture which enables rapid reconfigurability of the voltage pattern applied to control elements (typically voltage controlled capacitors) on the high impedance surface via control signal lines and hence phase properties of the high impedance surface. In the prior art, a planar N×N array of pads or electrodes on the high impedance surface are interconnected by variable capacitors. The capacitors are used for beam steering and phase modulation of the high impedance surface by appropriately programming their individual capacitances using control voltages applied thereto. The individual capacitor control lines are each connected to a remote analog voltage-source, the individual capacitor control lines being used to route and apply specified individual voltages onto a given metal pad. The number of control lines necessary increases geometrically with the number of metal pads as N². As the array size of electrodes increases (to some large value of N), the number of control signals needed in this architecture for the associated capacitors causes the number of control signal lines to increase significantly. As a result it becomes very difficult to design a large number of control signal lines in a high impedance surface of practical design having a large array of electrodes.

A new control architecture is proposed herein utilizes digital input signals to specify voltage on a given pad. The digital data signal is sent to a D/A microchip that interprets the data and applies the appropriate scaled voltage onto a given metal pad, thereby controlling the local phase variation of the tunable impedance surface. D/A microchips with single or multiple data line inputs and single or multiple voltage signal outputs may be utilized. Because the performance of the surface is highly sensitive to impedance characteristics, developing a high bit resolution D/A architecture scheme is also necessary.

This invention also provides an improved method to digitally control the application of high resolution voltage signals across many independent areas on a tunable impedance surface. By applying these signals across a tunable impedance surface high speed, electronic steering an RF or microwave beam is possible over a broad frequency range and with no moving parts. It provides a new control architecture for a tunable impedance surface by incorporating single or multiple D/A microchips away from the tunable surface (on either the backside or on a separate area). By applying high (digital) resolution voltage signals across a tunable impedance surface, electronic tuning of that surface can be achieved (by modifying the local voltage values) thereby changing the reflection phase. By programming voltage, hence the reflection phase, as a function of position across the surface, a reflected beam can be electronically scanned or focused with no mechanical motion.

As in the prior art tunable impedance surfaces, beam steering is accomplished electronically using variable capacitors, thus eliminating expensive phase shifters and unreliable mechanical gimbals. The reflective scanning approach eliminates the need for a conventional phased array, with separate phase shifters on each radiating element. The steerable surface can serve as a reflector for any static, highly directive feed antenna, thus removing much of the complexity and cost of conventional, steerable antenna systems.

The present invention applies to a range of antenna applications where steering or focusing of electromagnetic radiation is relevant. It has applications in space-based radar and airborne communication node (ACN) systems where rapid scanning of a mechanical system would require complex and expensive gimbal systems. It can be used to replace a fixed reflector with an adaptive planar reflector, and provide for beam direction and/or tracking. Hughes, G M, Raytheon ant the DoD have important needs for advanced conformal low profile antennas that can be manufactured at low cost. There may also be commercial applications for multi-functional apertures that could be of interest.

The prior art includes the following:

1) Daniel G. Gonzalez, Gerald E. Pollen, and Joel F Walker, “Microwave phasing structure for electromagnetically emulating reflective surfaces and focusing elements of selected geometry,” U.S. Pat. No. 4,905,014 issued Feb. 27, 1990. This patent describes placing antenna elements above a planar metallic reflector for phasing a reflected wave into a desired beam shape and location. It is a flat array that emulates other shaped reflective surfaces (such as a dish antenna).

2) D. Sievenpiper, E. Yablonovitch, “Circuit and Method for Eliminating Surface Currents on Metals” U.S. Pat. No. 6,262,495 issued Jul. 17, 2001. This patent relates to the original disclosure of the high impedance or Hi-Z surface. The technology described therein presents an approach for electronically tuning the reflection phase of a High-Z surface.

3) D. Sievenpiper, Robin Harvey, Greg Tangonan, RobertY. Loo, James H. Schaffner, “Tunable Impedance Surface” U.S. Pat. No. 6,538,621 issued Mar. 25, 2003. This patent describes a tunable impedance surface for electronically altering the reflection phase of this surface thereby enabling steering and/or focusing of a radio frequency (RF) beam.

A high impedance surface 8, shown in FIGS. 1(a) and 1(b), consists of an array of metal elements 10 disposed on dielectric media 12 which in turn is typically disposed or arranged on a flat metal ground plane 14. The high impedance surface 8 can be fabricated using printed circuit board technology, in which vertical connections are formed as metal plated vias 16, which connect alternating metal plates 10-1 on the top surface to the solid conducting ground plane 14 on the bottom surface or connect other alternating metal plates 10-2 on the top surface to controlled voltage sources 18. The metal elements 10 are arranged in a two-dimensional array. Both the metal elements 10 and the thickness of the structure measure much less than one wavelength. While alternating elements 10-1 are coupled to the ground plane 14 by means of plated metal vias 16-1, the interposed alternating metal elements 10-2 are coupled to controlled voltage sources 18 for the purposed of controlling the capacitances of the voltage controlled capacitor (variactors) 20 which are coupled between adjacent metal elements 10. By varying the voltages at the controlled voltage sources 18 those skilled in the art can modify the impedance function of the high impedance surface as a function of position on the surface.

FIG. 1(c) is a schematic drawing of control architectures for the tunable high impedance surface 8 of Figures l(a) and l(b). The prior art, depicted by FIGS. 1(a)-1(c), relied on analog control signals from voltage sources 18 being routed to every other individual metal element 10 of the high impedance surface 8.

The properties of this high impedance surface 8 can be explained using an effective medium model, in which it is assigned a surface impedance equal to that of a parallel resonant LC circuit shown in FIG. 2. The use of lumped parameters to describe electromagnetic structures is valid when the wavelength is much longer than the size of the individual features, as is the case here. When an electromagnetic wave interacts with the surface, it causes charges to build up on the ends of the top metal plates. This process can be described as governed by an effective capacitance. As the charges travel back and forth, in response to a radio-frequency field, they flow around a long path through the vias 16-1, 16-2 and the bottom metal surface 14 (at the frequencies involved, the voltage sources, appear to be at ground potential for this model). Associated with these currents is a magnetic field, and thus an inductance. The origin of the effective circuit elements is illustrated in FIG. 2. The inductance is still present even if the vias are absent, and is then governed by the currents flowing in the upper and lower metal plates 10, 14.

The presence of the array of resonant LC circuits affects the reflection phase of the surface 8. Far from resonance, the surface 8 reflects RF waves with a n phase shift, just as an ordinary conductor does. At the resonance frequency, the surface 8 reflects with a zero phase shift. As the frequency of the incident wave is tuned through the resonance frequency of the surface, the reflection phase changes by one complete cycle, or 2π. This is seen in both the calculated and measured reflection phase, shown in FIG. 3 and FIG. 4 respectively.

When the reflection phase is near zero, the structure also effectively suppresses surface waves, which has been shown to be significant in antenna applications.

Structures of this type have been constructed in a variety of forms, including multi-layer versions with overlapping capacitor plates. Examples have been demonstrated with resonance frequencies ranging from hundreds of MHz to tens of GHz, and the effective medium model presented here has proven to be an effective tool for analyzing and designing these materials, now known as Hi-Z surfaces.

### BRIEF DESCRIPTION OF THE PRESENT INVENTION

The present invention provides a tunable impedance surface which includes a two dimensional array of conducting plates disposed adjacent a dielectric medium and a ground plane spaced from said two dimensional array of conducting plates. The dielectric medium is disposed at least between and separating the two dimensional array of conducting plates and the ground plane. Conductors are provide which couple alternating ones of the conducting plates of the two dimensional array of conducting plates to the ground plane. A plurality of voltage controlled capacitors are coupled between adjacent plates in the two dimensional array of conducting plates and an array of digital to analog converters are disposed on or adjacent the ground plane, each analog converter in the array of digital to analog converters having one or more analog output voltage pads coupled to selected ones of adjacent conducting plates and having a digital input for receiving digital words representing at least in part analog voltages to be applied to the selected ones of the adjacent conducting plates.

### BRIEF DESCRIPTION OF THE FIGURES

FIG. 1(a) depicts a plan view of a prior art high impedance surface fabricated using printed circuit board technology wherein alternating metal plates on the top side of the printed circuit board connect through metal plated vias to a metal ground plane on the bottom surface, while the other metal plates are coupled to control voltages for the purpose of controlling the capacitances of the voltage controlled capacitors (varactors).

FIG. 1(b) is a side view of the high impedance surface of FIG. 1(a) with top and side views showing varactor orientation and voltage connections.

FIG. 1(c) is a schematic drawing of control architectures for tunable impedance surface)of FIGS. 1(a) and 1(b).

FIG. 2 is a schematic diagram of the capacitance and inductance in the effective medium model. The capacitance is controlled by the proximity of the adjacent metal plates, while the inductance is controlled by the thickness of the structure.

FIG. 3 is a graph depicting the calculated reflection phase of the high-impedance surface, obtained from the effective medium model. The phase crosses through zero at the resonance frequency of the structure.

FIG. 4 is a graph depicting the measured reflection phase agrees well with the calculated reflection phase, reinforcing the validity of the effective medium model.

FIG. 5 is a layout schematic of the digital architecture implemented to control and transmit voltages across a tunable high impedance surface. Voltages are applied to the top metal pad layers through the use of several control signals, voltage power layers and an input-output (I/O) data layer. The D/A converter microchips are located below a ground plane effectively isolating them from the top layer of the tunable high impedance surface.

FIG. 6(a) is a graph depicting phase versus frequency plot for various capacitance ranges (C1<C2<C3). The capacitance is controlled by the proximity of the adjacent cell metal plates and inter-cell voltage values, which is directly controlled by the applied voltage levels to each cell, the voltage values controlling the amount of capacitance contributed by the varactors shown in FIG. 7(a).

FIG. 6(b) is a plot of RF gain versus angle showing increased sidelobes as a result of phase error.

FIG. 6(c) demonstrates that when substrate thickness is reduced the amount of phase error is also reduced however to take full advantage of this benefit accurate, high resolution phase control is necessary. This can be achieved through the implementation of high bit level (10-16 bit) D/A converter microchips.

FIGS. 7(a) and 7(b) depict plan and side elevation views of a tunable high impedance surface, preferably fabricated using printed circuit board technology, wherein alternating metal plates on the top side of the printed circuit board connect through metal plated vias to a metal ground plane on the bottom side, while the other metal plates are coupled to control voltages produced by a D/A convertor for the purpose of controlling the capacitances of the voltage controlled capacitors (varactors).

FIG. 7(c) is schematic diagram of a simple embodiment of the digital architecture proposed herein for controlling the tunable high impedance surface of FIGS. 7(a) and 7(b). This architecture allows for a significant reduction in the number of required control signals as well as more manageable data specification via digital word bytes. This architecture is also much more convenient for large antenna array scaling and can be implemented in serial, parallel, or hybrid serial and parallel binary control schemes.

FIG. 7(d) shows how the DACs depicted by FIG. 7(c) preferably receive data which includes both a pad address and a pad voltage representation.

FIG. 7(e) depicts an embodiment where four DACs are chained together serially by a data bus and wherein each DAC controls the analog voltages on the ungrounded plates of a set of plates.

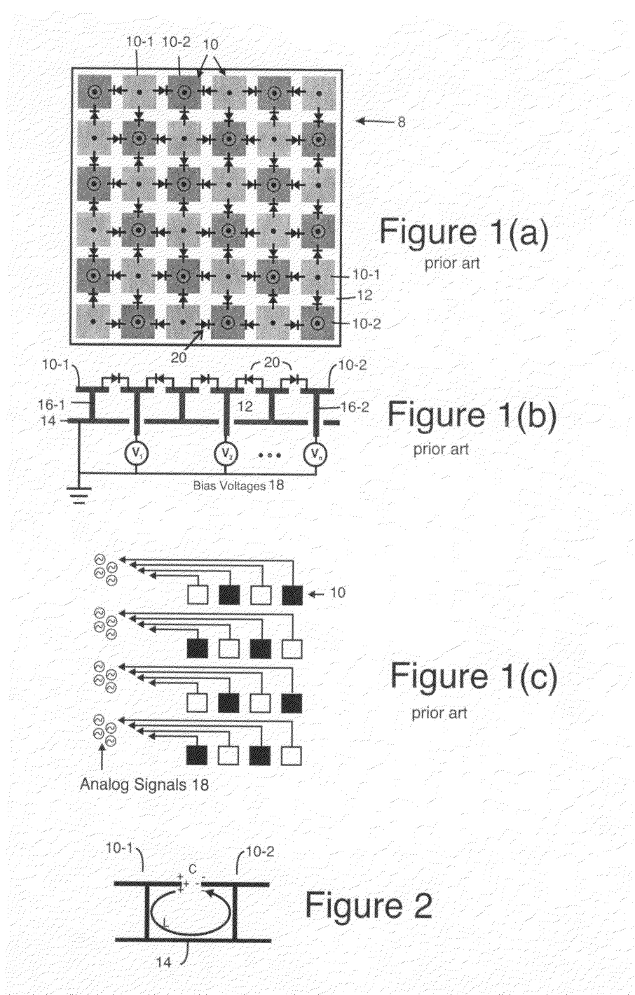

### DETAILED DESCRIPTION

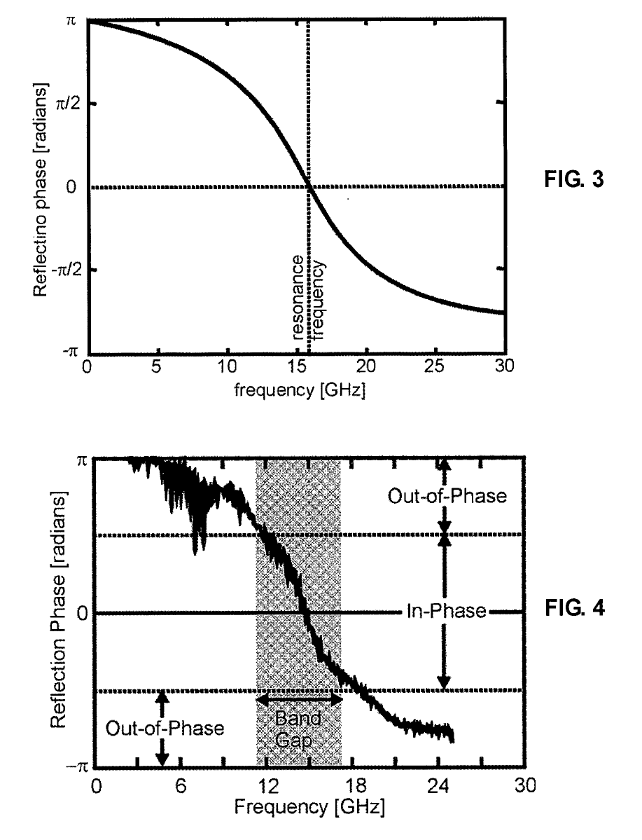

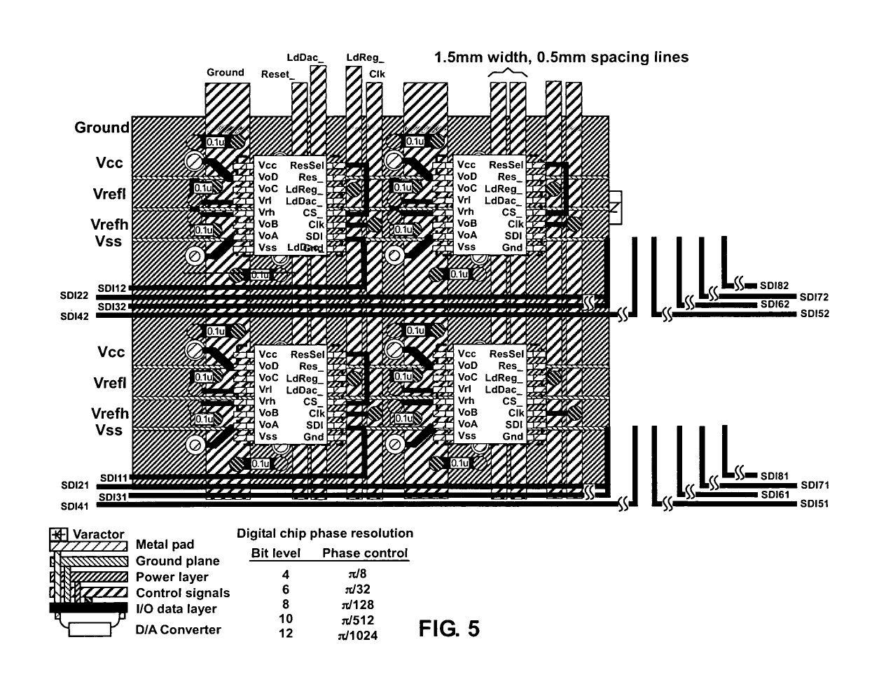

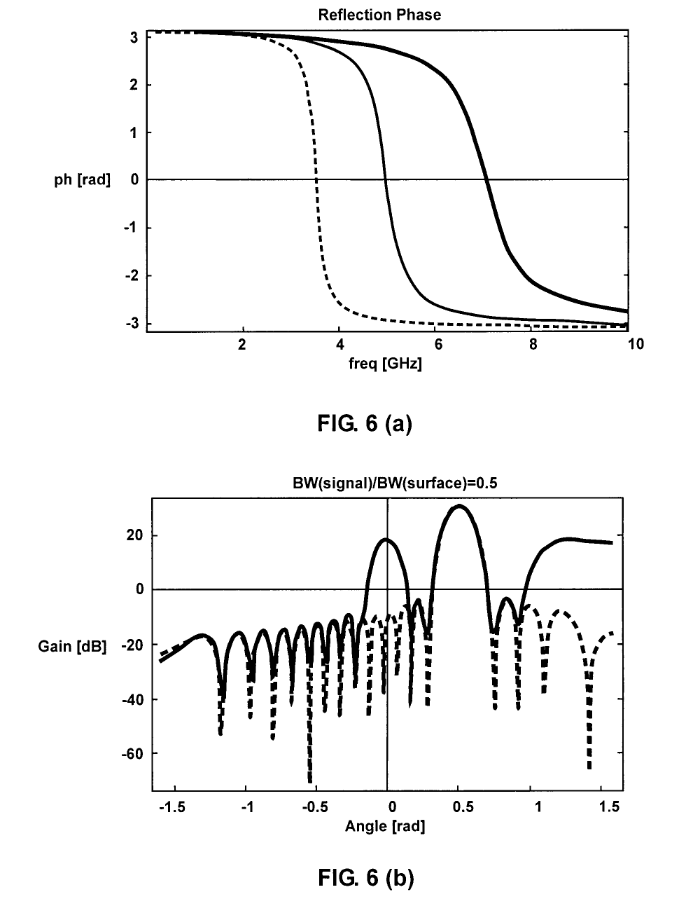

This invention involves the use of a control architecture to transmit and deliver control voltages to a tunable impedance surface 8′. As in the prior art embodiments of this tunable impedance surface 8′, conductive plates 10 and capacitors 20 disposed on or near an upper surface thereof help form the tunable surface 8′. The plates 10 are electrically conductive and preferably are physically smaller when viewed in a plan view than the operating wavelength of the surface 8′. A high impedance surface 8′ of reasonable size may consist of tens or hundreds or even thousands of these tiny elements or plates 10 which form small resonant circuits of the type shown in FIG. 2. Each element or plate 10 is connected to one or multiple electrically tunable capacitors (e.g. varactors) 20 which allow the reflection phase of the surface 8′ to be tuned as a function of position on the surface. This enables a beam emanating from or reflected off the surface 8′ to be steered or focused in any direction by imparting a linear or even a curved slope on the reflection phase. A RF beam can be reflected off the surface 8′ by directing an antenna, such as a horn antenna, towards the surface 8′ and allowing its RF beam to reflect off at a desired angle and orientation. Alternatively, antenna elements can be disposed directly on (or very near to) the surface 8′ and the RF beam emanating therefrom

If the geometry of the tunable high impedance surface 8′ is chosen such that the reflection phase changes by 2π within a fractional bandwidth, then any desired phase can be achieved by adjusting the control voltages on lines 26. For beam steering, since a total phase change of 2π is desired the bandwidth of the tunable high impedance surface should be kept small by making the structure thin. U.S. Pat. No. 6,538,621 explains how the array elements or plates 10 on the tunable impedance surface provides the ability to perform beam steering.

The tunable impedance surface 8′ may be conveniently manufactured using printed circuit board manufacturing technologies. The upper surface is preferably etched to form an array of metallic plates 10, some of which (see elements 10-1) are coupled to a ground plane 14 formed on a lower surface. If a printed circuit board is etched to define these surfaces, then the board will have a dielectric substrate 12 which conveniently supports the plates 10 and the ground plane 14 on opposing surfaces thereof. Others of the plates 10 (see elements 10-2) are arranged to receive a control voltage on lines 26 generated by a Digital to Analog (D/A) convertor 22.

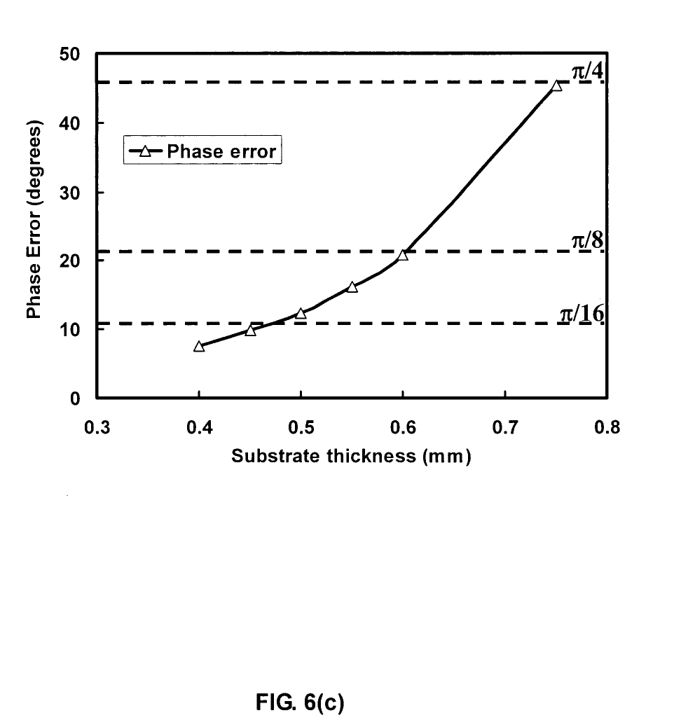

In the current invention, D/A convertors 22 are preferably implemented by integrated circuit devices, to interpret digital input data 24 and convert that data into a discrete analog voltage output on plates 10-2 across a tunable impedance surface 8′, which voltages control the capacitances contributed to the circuit of FIG. 2 by varactors 20. A schematic of a sample control board layout that has been implemented to demonstrate the feasibility of such a digital architecture and is shown in FIG. 5. The digital control architecture has several key benefits that enable enhanced performance from the tunable impedance surfaces. These performance enhancements are:
The ability to send large amounts of signal data across a single or few control lines to the tunable array. This allows reduction of line capacitance, layout complexity and signal routing.
The capability to control a large number of independent tunable surface metal pads with one or only a few D/A converters. Commercially available D/A converters can allow for as many as sixteen voltage outputs with only one digital input data line thereby reducing the number of control line input signals by greater than an order of magnitude. It is conceivable that 20, 50, or 100 output D/A converter microchips can be custom fabricated for increased performance.
The flexibility to implement a parallel or serial data transmission architecture across several D/A converters. This can allow for both redundancy (increased reliability) of the data signal and voltage routing as well as scalability to create large tunable surface antenna arrays with 1000's, 10000's or 100000's of individual elements.
High resolution (high bit level) D/A microchips allow precise control of exact voltage and hence phase value at any given location on the tunable impedance surface.

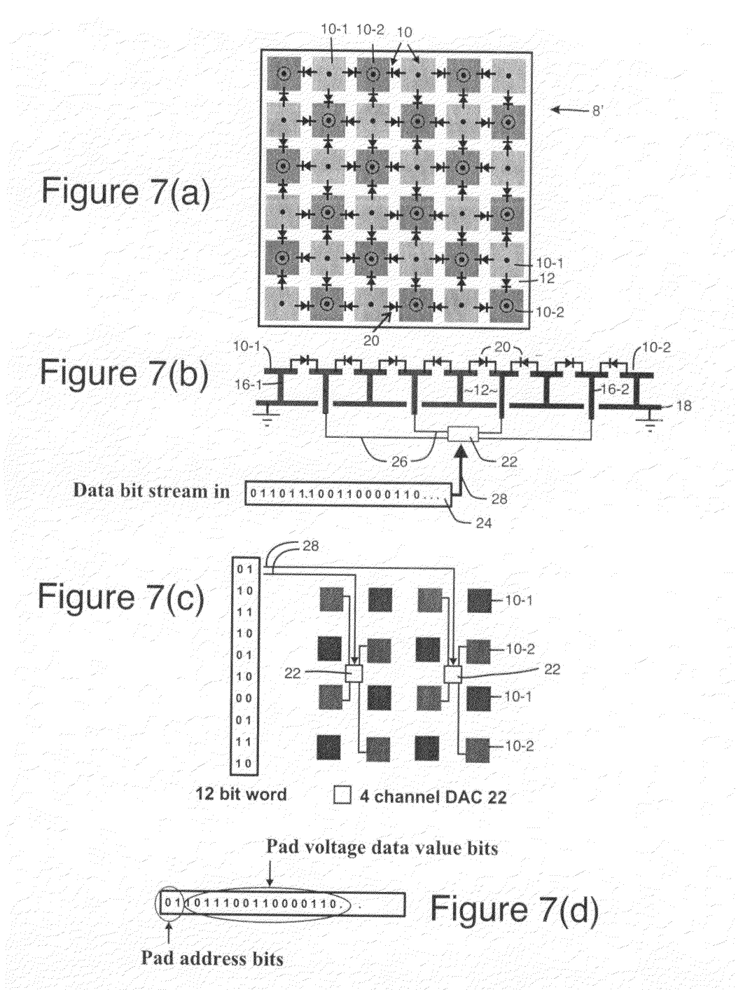

High bit level resolution allows for precise control of voltages, and hence phase values, across the tunable impedance surface. This results in improved device performance in terms of reduced signal loss, greater phase tuning capability, and decreased signal sidelobes. FIG. 6a illustrates the typical phase and gain plots associated with this type of steerable antenna array. In general a phase versus frequency curve minimizes the phase error when it spans the full range of −π to π radians (−180 to 180 degrees). Better phase control and reduced phase error will result in better performance and decreased sidelobes in the gain spectrum (see FIG. 6b).

If the D/A convertors 22 each produce P independent control voltages on lines 26 then an N·M array of elements 10 would require N·M/2P convertors 22.

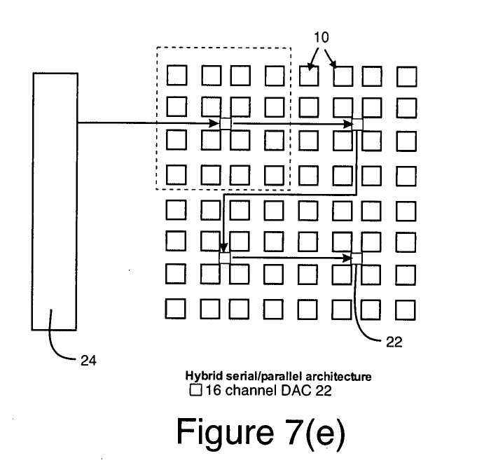

FIG. 7(c) shows the D/A convertors 22 to be independent of one another. But they can alternatively be chained together as shown in FIG. 7(e). Considering FIG. 7(c) first, a multi-bit word 24 of data controls the voltage generated at each output of the DAC 22. In the embodiment of FIG. 7(c) each DAC 22 controls the voltages applied to four plates 10-2, so P=4 in this embodiment. Each DAC would receive P words 24 in succession, one for each output, and then the words 24 would cycle again through the P words 24, with their values changing as needed when a beam is steered by the tunable impedance surface 8′. Each DAC 22 would separately receive P words 24 of data for its particular set of P outputs (or pads). In order to distinguish which serial word corresponds to which pad (output), the DAC 22 preferably receives data 24 which includes both a pad address and a pad voltage component as depicted by FIG. 7(d). The number of bits in the pad address portion will depend on the value of P and the number of bits in the voltage data value portion of word 24 will depend on the voltage resolution desired.

FIG. 7(e) shows an embodiment where four DACs 22 are chained together serially by a data bus 28. Each DAC 22 controls the analog voltages on the ungrounded plates 10-2 of a set of plates 30. The individual analog voltage lines 26 (shown in FIG. 7(b)) are omitted from this schematic diagram for ease of illustration, but such lines 26 would be provided to impress the analog control voltage on each ungrounded plate 10-2, as shown by FIG. 7(c) for example. The remaining plates 10-1 (see FIGS. 7(a)-7(c)) are preferably coupled to ground plate 14 as previously described. In such an embodiment the data words 24 would then also preferably include additional bits to individually address each chained DAC 22. The number of DACs 22 in a single serial chain can be increased to decreased as desired as a matter of design choice as can the number of plates 10-2 controlled by a single DAC 22.

The discussion above relative to FIGS. 7(a)-7(e) has assumed that the words 24 of data are transmitted serially. But a parallel bus arrangement can certainly be used instead if there is sufficient space between neighboring plates 10 to accommodate the additional wires associated with a parallel bus. Alternatively the bus 28 (serial or parallel) can be routed on a different layer in a multiple layer printed circuit board configuration (assuming that printed circuit board techniques are used, as is currently preferred, to make the disclosed tunable impedance surface 8′, in which case there should be ample space for a parallel bus arrangement). Also, instead of including chip address bits in the word 24 when the DACs 22 are chained as shown in FIG. 7(e), a chip select signal can be used instead of such bits. Or in combination with such bits if desired.

The plates 10 are depicted as being square herein, but those skilled in the art will appreciate that other shapes can alternatively be utilized as discussed for example in U.S. Pat. No. 6,538,621 mentioned above. The control voltages applied to the plates 10-2 on lines 26 can range, for example, between −10 volts and +10 volts. The voltage range selected will depend upon the capabilities and range of the voltage controlled capacitors 20.

Having described the invention in connection which a preferred embodiment thereof, modification will now suggest itself to those skilled in the art. As such the invention is not to be limited to this disclosed embodiment expect as specifically required by the appended claims.

What is claimed is:

1. A tunable impedance surface comprising:
a two dimensional array of conducting plates disposed adjacent a dielectric medium;
a ground plane spaced from said two dimensional array of conducting plates, the dielectric medium occurring at least between and separating said two dimensional array of conducting plates and said ground plane;
conductors coupling alternating ones of said conducting plates of said two dimensional array of conducting plates to said ground plane;
a plurality of voltage controlled capacitors coupled between adjacent plates in said two dimensional array of conducting plates; and
an array of digital to analog converters disposed on or adjacent said ground plane, each analog converter in said array of digital to analog converters having analog output voltage pads coupled to selected ones of adjacent conducting plates and having a digital input for receiving digital words representing at least in part analog voltages to be applied to the selected ones of the adjacent conducting plates.

2. The tunable impedance surface of claim 1 wherein the array of digital to analog converters includes digital to analog converters that are chained together to receive and pass along digital data from one digital to analog converter to another digital to analog converter in each chain.

3. The tunable impedance surface of claim 1 wherein the array of digital to analog converters are addressed by binary data that includes a multi-bit representations of voltage data values corresponding to control voltages to be applied to each of the voltage controlled capacitors.

4. A method of digital control of a tunable impedance surface having:
a two dimensional array of conducting plates disposed adjacent a dielectric medium;
a ground plane spaced from said two dimensional array of conducting plates, the dielectric medium occurring at least between and separating said two dimensional array of conducting plates and said ground plane;
conductors coupling alternating ones of said conducting plates of said two dimensional array of conducting plates to said ground plane; and
a plurality of voltage controlled capacitors coupled between adjacent plates in said two dimensional array of conducting plates;
the method comprising:
disposing an array of digital to analog converters on or adjacent said ground plane,
coupling having analog output voltage pads of each digital to analog converter in said array of digital to analog converters to selected ones of adjacent conducting plates,
applying digital data to a digital input of each analog converter in said array of digital to analog converters, the digital data representing at least in part analog voltages to be applied to the selected ones of the adjacent conducting plates.

5. The method of digital control of a tunable impedance surface according to claim 4 further including serially coupling at least selected ones of the plurality of digital to analog converters in said array of digital to analog converters whereby downstream-connected digital to analog converters in said array of digital to analog converters receive the digital data from an uptream-connected digital to analog converter in said array of digital to analog converters and wherein the step of applying digital data includes supplying addressing information with the digital data, the addressing information being used by the plurality of digital to analog converters to select a particular one digital to analog converter in a serially-connected group of digital to analog converters to be responsive to the digital data being serially communicated thereto.
